(19) United States
(12) Patent Application Publication
(10) Pub. No.: US 2019/0034662 A1
(43) Pub. Date: Jan. 31, 2019

(54) SOFTWARE FIREWALL

(71) Applicant: IDEMIA IDENTITY & SECURITY FRANCE, ISSY LES MOULINEAUX (FR)

(72) Inventors: Lauren DEL GIUDICE, ISSY LES MOULINEAUX (FR); Rémi Louis Marie DUCLOS, ISSY LES MOULINEAUX (FR); Yoann FAGES-TAFANELLI, ISSY LES MOULINEAUX (FR)

(73) Assignee: IDEMIA IDENTITY & SECURITY FRANCE, ISSY LES MOULINEAUX (FR)

(21) Appl. No.: 16/042,481

(22) Filed: Jul. 23, 2018

(30) Foreign Application Priority Data
Jul. 27, 2017 (FR) 17/57125

(51) Int. Cl. G06F 21/62; G06F 21/77

(52) U.S. Cl. CPC G06F 21/6281; G06F 2221/2141; G06F 21/77

(57) ABSTRACT

Applets (AA1, AB1) are developed in object-oriented language and compiled in bytecode. A software firewall of an operating system installed in an electronic component of the iUICC type or on an electronic card of the eUICC type checks execution thereof. The operating system comprises an interpreter interpreting and executing the bytecode of the applets (AA1, AB1), each applet (AA1, AB1) being associated with a single context (CA1, CB1, JB), each context (CA1, CB1, JB) being associated with one or more applets. In addition, each context (CA1, CB1, JB) is associated with a single use profile (PA, PB) among a plurality of use profiles, and each use profile (PA, PB) is associated with one or more contexts (CA1, CB1, JB). When the software firewall is informed by the interpreter of an access to a static data item from a first applet (AB1) to a second applet (AB3, AA1), the software firewall: determines a source profile of the access to the static data item; determines a destination profile of the access to the static data item; refuses access to the static data item when the source profile is not identical to the destination profile, and applies intercontext access checking rules otherwise.

### FIELD OF THE INVENTION

The present invention relates to a software firewall installed on an electronic card, such as a smartcard, on which a plurality of use profiles coexist. The present invention also relates to a method implemented by such a software firewall.

### PRIOR ART

A smartcard comprises at least one integrated circuit capable of containing and processing information. The integrated circuit, i.e. the chip, contains a microprocessor or microcontroller capable of processing the information, which is stored in a non-volatile memory. The microprocessor or microcontroller enables implementing an operating system that performs information exchanges and processing operations carried out in the smartcard. The operating system defines an environment for execution of a bytecode independent of smartcard hardware by virtue of which applications, referred to as applets, are executed. This execution environment is known as JCRE (Java Card Runtime Environment) in Java Card terminology, which is a technology widespread in the design of smartcards. The operating system comprises an interpreter affording execution of the bytecode of the applets installed in non-volatile memory on the smartcard. This interpreter is called a virtual machine, JCVM (Java Card Virtual Machine), in Java Card terminology. The operating system also comprises a set of libraries containing the basic functions (APIs, standing for “Application Programming Interfaces”) useful to the development of applets for smartcards. For full details on Java Card technology, reference can be made in particular to the Java Card Classic Platform specifications, version 3.0.4.

Smartcards are mainly used as personal identification or payment means or proof of subscription to pre-paid services. Thus smartcards typically contain data considered to be confidential. Smartcards may also be subject to attacks, the purpose of which is to recover these confidential data. These attacks may be physical or logical. Logical attacks consist of causing the operating system, and more particularly the interpreter, to execute malevolent applications, which for example contain fraudulent bytecode sequences.

There exist software firewalls that provide checks on access rights between execution contexts of the applets, so as to allow access to one target applet in one context by another applet in another context only if the target applet offers a shareable interface. However, such software firewalls are not suitable for taking into account situations in which the target applet offers a shareable interface only to a subset of other applets executed on the smartcard. In particular, such software firewalls are not suitable for taking into account situations in which accesses to static data must be controlled. These cases occur in particular when the use of a smartcard is shared by a plurality of separate operator services, as is the case in electronic cards of the eUICC (embedded Universal Integrated Circuit Card) type. Mention can be made for example of the case of a SIM (Subscriber Identity Module) card allowing access to telephony services offered by separate operators. The access rights offered by the shareable interface provided by an applet would then be distinct depending on whether the applet is accessed via another applet from the same operator or whether the applet is accessed via another applet from another operator, in which case a certain hermeticity must be ensured so as to avoid offering the possibility of one operator recovering or contaminating the data of another operator. Other examples of use of an electronic card of the eUICC type in a multiservice context can be constructed on the same model.

In addition, the problems described above are not limited to the context of electronic cards of the eUICC type. Indeed, the same problems are posed vis-à-vis iUICC (integrated Universal Integrated Circuit Card) electronic components.

### DISCLOSURE OF THE INVENTION

It is desirable to overcome these problems of the prior art. It is particularly desirable to provide a solution that resists the aforementioned logical attacks, of increased reliability.

To this end, the invention relates to a method for checking execution of applets developed in object-oriented language and compiled in bytecode, the method being implemented by a software firewall of an operating system installed in an electronic component of the iUICC type or on an electronic card of the eUICC type, the operating system comprising an interpreter that is a software interpreting and executing the bytecode of the applets, each applet being associated with a single context, each context being associated with one or more applets. Each context is associated with a single use profile among a plurality of use profiles, and each use profile is associated with one or more contexts. When the software firewall is informed by the interpreter of an access to a static data item from a first applet to a second applet, the software firewall performs the following steps: determining a source profile of the access to the static data item, which is the profile associated with the context with which the first applet is associated; determining a destination profile of the access to the static data item, which is the profile associated with the context with which the second applet is associated; checking whether the source profile of the access to the static data item is identical to the destination profile of the access to the static data item; when the source profile of the access to the static data item is not identical to the destination profile of the access to the static data item, refusing access to the static data item; and, when the source profile of the access to the static data item is identical to the destination profile of the access to the static data item, applying intercontext access checking rules.

Thus, by virtue of the definition of the concept of use profile integrating the concept of context, and by virtue of the behaviour of the software firewall faced with access to static data between applets, the static data of a use profile are protected from access from another use profile although access to such static data does not involve a context switch.

According to a particular embodiment, one of said use profiles is a particular profile, referred to as “system profile”, managed separately from the other use profiles by the software firewall, so that, when the source profile of the access to the static data item is the system profile, the software firewall applies the intercontext access checking rules and, when the destination profile of the access to the static data item is the system profile, the software firewall refuses access to the static data item.

According to a particular embodiment, when the software firewall is informed by the interpreter of an access to a non-static data item or to a method from a first applet to a second applet, the software firewall performs the following steps: determining the source profile of the access to the non-static data item or to the method; determining the destination profile of the access to the non-static data item or to the method; checking whether the source profile of the access to the non-static data item or to the method is identical to the destination profile of the access to the non-static data item or to the method; when the source profile of the access to the non-static data item or to the method is not identical to the destination profile of the access to the non-static data item or to the method, refusing access to the non-static data item or to the method; and, when the source profile of the access to the non-static data item or to the method is identical to the destination profile of the access to the non-static data item or to the method, applying intercontext access checking rules. Thus the non-static data and/or the methods benefit from the same protection level as the static data.

According to a particular embodiment, when the source profile of the access to the non-static data item or to the method is the system profile, the software firewall applies the intercontext access checking rules, and, when the destination profile of the access to the non-static data item or to the method is the system profile, the software firewall (FW) refuses access to the non-static data item or to the method.

The invention also relates to a software firewall configured to perform a checking of execution of applets developed in object-oriented language and compiled in bytecode, the software firewall being intended to belong to an operating system intended to be installed in an electronic component of the iUICC type or on an electronic card of the eUICC type, the operating system comprising an interpreter that is a software interpreting and executing the bytecode of the applets, each applet being associated with a single context, each context being associated with one or more applets. Each context is associated with a single use profile among a plurality of use profiles, and each use profile is associated with one or more contexts. When the software firewall is informed by the interpreter of an access to a static data item from a first applet to a second applet, the software firewall performs the following steps: determining a source profile of the access to the static data item, which is the profile associated with the context with which the first applet is associated; determining a destination profile of the access to the static data item, which is the profile associated with the context with which the second applet is associated; checking whether the source profile of the access to the static data item is identical to the destination profile of the access to the static data item; when the source profile of the access to the static data item is not identical to the destination profile of the access to the static data item, refusing access to the static data item; and, when the source profile of the access to the static data item is identical to the destination profile of the access to the static data item, applying intercontext access checking rules.

The invention also relates to an electronic card of the eUICC type comprising an operating system integrating a software firewall as dealt with above, configured to perform a checking of execution of applets developed in object-oriented language and compiled in bytecode.

According to a particular embodiment, the electronic card of the eUICC type is a SIM card and the use profiles are respectively associated with telephony services of separate operators.

The invention also relates to an electronic component of the eUICC type comprising an operating system integrating a software firewall as dealt with above, configured to perform a checking of execution of applets developed in object-oriented language and compiled in bytecode.

### LIST OF FIGURES

The features of the invention mentioned above, as well as others, will emerge more clearly from a reading of the following description of an example embodiment, said description being given in relation to the accompanying drawings, among which:

FIG. 1A illustrates schematically a hardware architecture of a smartcard, in which the present invention may be implemented;

FIG. 1B illustrates schematically a hardware architecture of an electronic component in which the present invention may be implemented;

FIG. 2 illustrates schematically a software organisation implemented by the smartcard;

FIG. 3 illustrates schematically a management of access between applets belonging to distinct contexts, according to a first embodiment;

FIG. 4 illustrates schematically a management of access between applets belonging to distinct contexts, according to a second embodiment;

FIG. 5A illustrates schematically an algorithm, implemented by the software firewall, for processing interapplet access, according to the first embodiment; and

FIG. 5B illustrates schematically an algorithm, implemented by the software firewall, for processing interapplet access, according to the second embodiment.

### DETAILED DESCRIPTION OF EMBODIMENTS

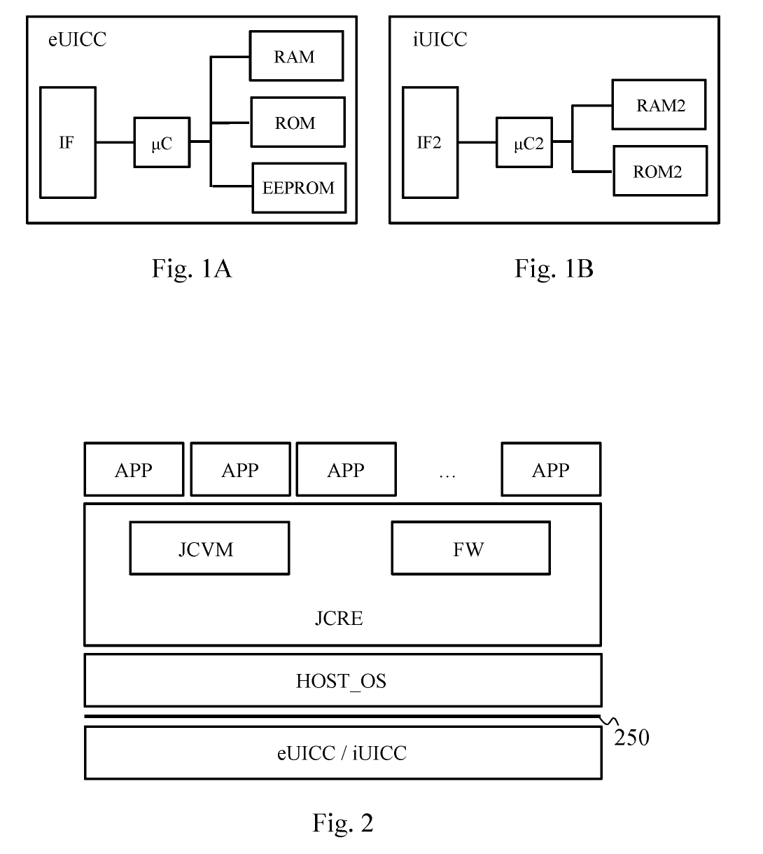

FIG. 1A illustrates schematically a hardware architecture of a smartcard, that is to say an electronic card, of the eUICC type, in which the present invention may be implemented.

The smartcard eUICC comprises an interface IF configured to connect the smartcard eUICC to a card reader (not shown in FIG. 1A). The smartcard eUICC is for example a multi-operator SIM (subscriber identity module) card and the card reader is included in a mobile telephony terminal. The smartcard eUICC may also be a multiservice bank card and the card reader is included in a bank terminal, or a multivendor loyalty card and the card reader is included in a cash register. In general terms, the present invention may be implemented in an electronic card, preferentially a smartcard, for which various parallel use profiles are required.

The interface IF is thus configured to enable making data exchanges between the card reader and the smartcard eUICC, in particular to enable the card reader to send commands to the smartcard eUICC, and also to enable the card reader to power the smartcard eUICC.

The smartcard eUICC further comprises a processor, typically in the form of a microcontroller μC or a microprocessor, responsible for performing processing operations in the smartcard eUICC: calculations, data processing and transfers, etc.

The smartcard eUICC further comprises a volatile memory, such as a random access memory (RAM), as well as at least one non-volatile memory, such as a read-only memory (ROM) and a EEPROM memory (Electronically Erasable Programmable ROM) or a Flash memory.

When the smartcard eUICC is powered by the card reader via the interface IF, the microcontroller μC is capable of executing instructions, in particular in the form of bytecode, from the read-only memory ROM and/or the EEPROM memory.

The read-only memory ROM and/or the EEPROM memory typically contain instructions causing implementation of an operating system, preferentially a JCRE environment according to the Java Card technology, relying on the non-volatile memory to create at least one execution stack for temporarily storing data, such as application data.

The EEPROM memory typically contains application instructions, referred to as applets, installed on the smartcard eUICC, and more particularly, when the application is instantiated, objects of said applications. The applets are developed in object-oriented language and compiled in bytecode. The control of the creation of these objects and the allocation of memory space for manipulating these objects are implemented by an interpreter, preferentially a JCVM (Java Card Virtual Machine) of the JCRE environment according to the Java Card technology, responsible for ensuring execution of the bytecode, read from the EEPROM memory, of the applications by the microcontroller μC.

It should be noted that, when the operating system is implemented on an electronic card other than a smartcard, the microcontroller μC is capable of executing instructions loaded in the random access memory RAM from the read-only memory ROM and/or from the EEPROM memory, once said electronic card is powered up.

FIG. 1B illustrates schematically a hardware architecture of an electronic component iUICC, in which the present invention may be implemented. FIG. 1B corresponds to an architecture known by the term SoC (System on Chip). The architecture presented in FIG. 1B is very similar to that presented in FIG. 1A and differs mainly in that it is integrated in a single electronic component. Thus the electronic component iUICC comprises an interface IF2 configured to connect the electronic component iUICC to other electronic components on an electronic card, typically via a communication bus.

The electronic component iUICC further comprises a processor core, typically in the form of a microcontroller core μC2, responsible for carrying out processing operations in the electronic component iUICC: calculations, data processing and transfers, etc.

The electronic component iUICC further comprises a volatile memory, such as a random access memory RAM2, as well as at least one non-volatile memory, such as a read-only memory ROM2.

When the electronic component iUICC is powered up, the microcontroller core μC2 is capable of executing instructions, in particular in the form of bytecode, from the read-only memory ROM2. The read-only memory ROM2 typically contains instructions causing implementation of an operating system, preferentially a JCRE environment according to the Java Card technology, relying on the non-volatile memory RAM2 to create, at least, an execution stack and to temporarily store data, such as application data. The memory ROM2 typically contains application instructions, referred to as applets, and more particularly, when the application is instantiated, the objects of said applications are stored in the random access memory RAM2.

FIG. 2 illustrates schematically a software organisation implemented by the smartcard eUICC or by the electronic component iUICC. A hard-soft interface 250 enables controlling the smartcard iUICC or the electronic component iUICC, as a hardware entity, by virtue of software instructions from said software organisation.

Said software organisation comprises an operating system part HOST_OS adapted to the hardware entity, in order to enable another part of the operating system consisting of the JCRE environment to make the smartcard eUICC function. The operating system part HOST_OS allows rendering the JCRE environment independent of the actual structure of the hardware entity.

The JCRE environment contains in particular the virtual machine JCVM, as well as a software firewall FW. The services of the JCRE environment are used by applications APP, referred to as applets, each created within a given context. Each context includes one or more applets. In Java Card terminology, the contexts are called packages. In other words, the applets are organised in namespaces that thus define a context for execution of said applets.

According to Java Card technology, the software firewall FW applies certain access checking rules when a first applet attempts to gain access (call, read or write) to a second applet belonging to a different context (or package). The software firewall FW then checks in particular with the second applet that said second applet provides a sharable interface and thus allows access from the first applet. Other intercontext access checking rules can be defined.

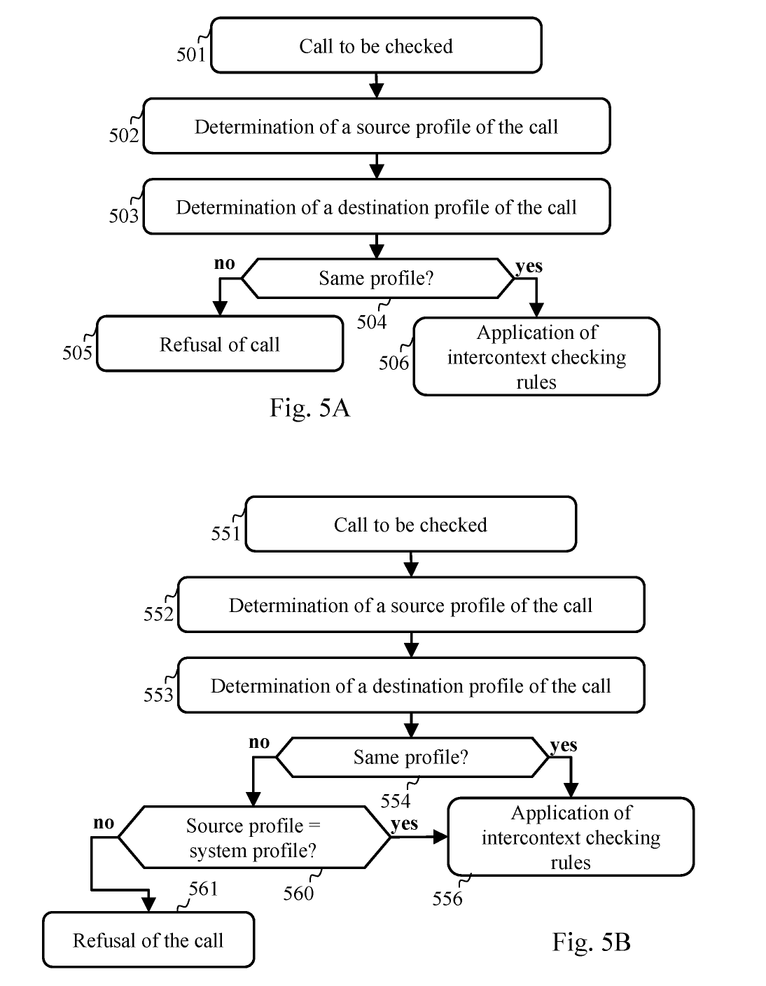

In the context of the present invention, the software firewall FW has complementary functionalities, so as to allow multiprofile management and prevent undesirable accesses being executed from an applet of a first use profile to an applet of a second use profile. The behaviour of the software firewall FW is detailed below in relation to FIG. 5A in a first embodiment. There may however exist a particular use profile (system profile), managed separately by the software firewall FW, with access rights particular to the other use profiles (ordinary profiles). This aspect corresponds to a second embodiment detailed below in relation to FIG. 5B.

In the context of the present invention, an access attempted by a first applet to a second applet means any of the following actions: the fact that an object of the first applet attempts to read or write in a static data item of objects of the second applet; the fact that an object of the first applet attempts to read or write in a non-static data item of an object of the second applet; and the fact that an object of the first applet attempts to have recourse to a method of an object of the second applet. Access therefore refers either to a static data item, or to a non-static data item, or to a method. It should be noted that controlling attempts at access to static data is a point of divergence of the approach of the present invention compared with Java Card technology. For example, in section 6.1.6 of the “Java Card Specification 2.2.2 Final Release-Runtime Environment Specification” of 2005, it is indicated that it is necessary to use objects with a sharable interface to share a data item through a plurality of contexts. However, replacing static data with shared-interface objects is much more expensive in terms of programming complexity and, in use, in terms of execution performance. The present invention allows protecting static data without having to transform them into shared-interface objects at the time of programming.

In the context of electronic cards of the eUICC type or electronic components of the iUICC type, protecting static data of the “reference” type poses a particular problem. The present invention ensures that a malicious operator cannot modify a reference that would be a static data item of a competing use profile installed on the same electronic card of the eUICC type or on the same electronic component of the iUICC type, and therefore allows preventing a denial of service DOS attack interfering with the correct functioning of the attacked use profile.

The software firewall FW thus allows managing multiprofile situations, namely when a plurality of use profiles coexist in the same electronic card of the eUICC type or the same electronic component of the iUICC type. Such a multiprofile situation is found for example when a SIM card enables accessing telephony services offered by separate operators. A use profile is then associated with each operator on the SIM card, and a use profile can be selectively activated among the various use profiles so as to be able to access the telephony services of the operator with which said use profile is associated. The software firewall FW enables ensuring that the applets of the active profile do not access or modify the data of the other use profiles, particularly with regard to the static data.

It should be noted that, on the eUICC smartcard or in the electronic component iUICC, only one context and only one profile (the one in which the context in question is located) are not active at the same time. The other contexts and the other profiles are created, but inactive. Selective changes of profiles occur during the use of the smartcard eUICC or of the electronic component iUICC, for example when a user of the smartcard eUICC or of the component iUICC switches from a telephony service subscribed with one operator to another telephony service subscribed with another operator, or when the user of said smartcard eUICC or of the electronic component iUICC switches from a service provided by a first vendor to a service provided by another vendor. It should also be noted that profile switches can be carried out manually or automatically. The profile that was active until then becomes inactive, and a profile that was inactive until then becomes active.

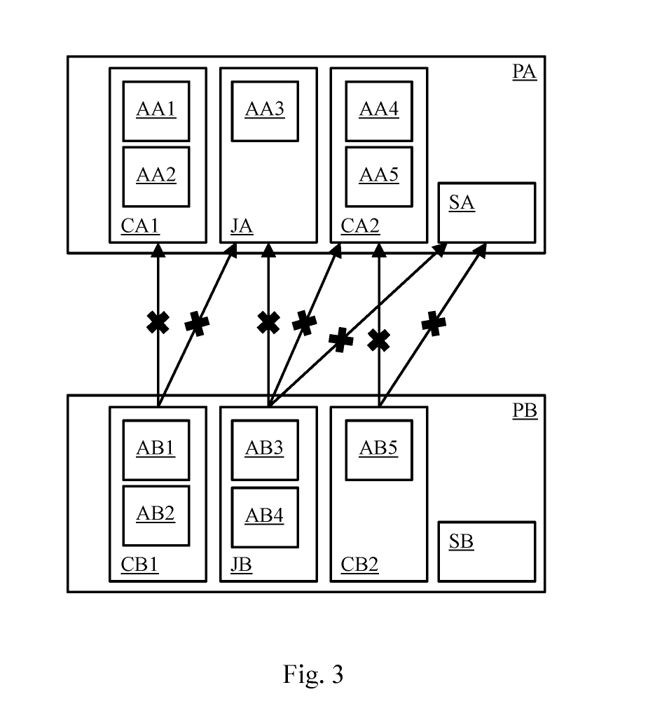

FIG. 3 illustrates schematically a management of access between applets belonging to separate contexts, according to the first embodiment.

Illustratively, in FIG. 3, two use profiles PA and PB are presented. For example, let us consider that the use profiles PA and PB are used in the context of the smartcard eUICC and that the smartcard eUICC is a SIM card. The profiles PA and PB then correspond to subscriptions to telephony services with separate operators or to subscriptions to telephony services for separate user names.

The profile PA contains a first context CA1 and a second context CA2. The first context CA1 contains an applet AA1 and an applet AA2. The second context CA2 contains an applet AA4 and an applet AA5. The profile PA further contains a third context JA intended for the applets instantiated by the JCRE environment when the profile PA is active. In FIG. 3, the third context JA contains an applet AA3. The profile PA further contains static data SA intended for the various contexts of the profile PA.

The profile PB contains a fourth context CB1 and a fifth context CB2. The fourth context CB1 contains an applet AB1 and an applet AB2. The fifth context CB2 contains an applet AB5. The profile PB further contains a sixth context JB intended for the applets instantiated by the JCRE environment when the profile PB is active. In FIG. 3, the sixth context JB contains an applet JB3 and an applet AB4. The profile PB further contains static data SB intended for the various contexts of the profile PB.

When an access is made between applets in the same use profile (intra-profile), the software firewall FW applies intercontext access checking rules, namely in particular the usual access checking rules already mentioned in the Java Card technology (such as are found in the Java Card Classic Platform version 3.0.4 specifications for example). The software firewall FW then checks with the targeted applet that said targeted applet provides a sharable interface and that said targeted applet thus enables access from another applet.

When access is made from a first applet belonging to a first use profile (e.g. the profile PB to a second applet belonging to a second use profile (e.g. the profile PA), the software firewall FW refuses access, even if the second applet provides a sharable interface and thus enables access from another applet. This ensures hermeticity between the use profiles, even if the access relates to a static data item.

FIG. 3 thus illustrates that the software firewall FW refuses any access occurring from the profile PA to the profile PB (and the same would apply to any access occurring from the profile PB to the profile PA). In particular, FIG. 3 shows that the following accesses are refused by the software firewall FW, independently of any sharable interface of the applet to which access is intended:
access from an applet of the context CB1 to an applet of the context CA1 (the same would apply to destined for the context CA2);
access from an applet of the context CB1 to an applet of the context JA (the same would apply from the context CB2);
access from an applet of the context JB to an applet of the context JA;
access from an applet of the context JB to the static data SA;
access from an applet of the context JB to an applet of the context CA2 (the same would apply to destined for the context CA1); and
access from an applet of the context CB2 to the static data SA (the same would apply from the context CB1).

Access to the static data of the profiles PA and PB are thus protected thanks to the software firewall FW. There is therefore no need of a context switch for this protection to be provided. As listed above, this protection also extends to accesses involving context switches.

One implementation possibility is to store in the interpreter a use profile identification table, which associates a use profile with each instance identifier. For a given object, the interpreter discovers the concerned instance identifier, and thus finds the concerned use profile.

However, in a preferential embodiment, the programmed objects have respective headers containing information on belonging to such or such use profile. It is stated here that the static data are concerned. This therefore assumes a modification at the memory model level compared with Java Card technology since, when a use profile is activated, information identifying said use profile, referred to as active profile, shall be stored by the operating system. The operating system stores and keeps this information as long as the smartcard eUICC and the electronic component iUICC are used. In addition, as the interpreter comprises an allocator responsible for memory applications, the allocator is also modified with respect to Java Card technology, in order to provide the active profile in the header of each newly created object. By storing the use profile information directly in the objects belonging to said use profile, access to the use profile information is particularly quick during interpretation of the bytecode that attempts to access said objects. Indeed, the fact that the use profile information is co-located with the actual data to be checked makes access thereto faster. The preferential embodiment allows avoiding the two indirections relating to the checking of the use profile identification table when an object is accessed. The preferential embodiment is therefore faster to execute, and avoids having to ensure that the same instance identifier is used for different use profiles.

Thus, in a particular embodiment, the bytecode whose interpretation is modified with respect to Java Card technology is:
for static data: getstatic, putstatic; and
for non-static data and methods: getfield, putfield, athrow, <T>aload, <T>astore, arraylength, checkcast, instanceof, invokevirtual, invokeinterface, invokespecial, invokestatic, where above <T> refers to the various types of array bytecode.

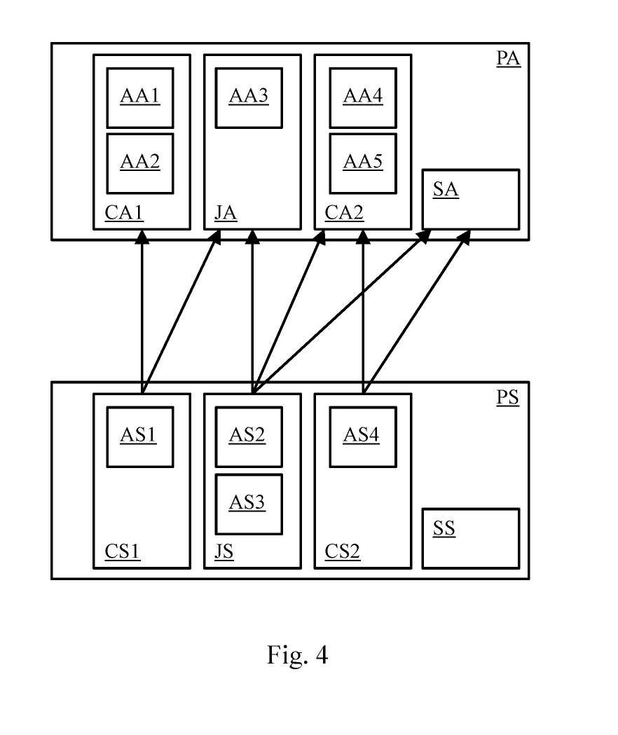

FIG. 4 illustrates schematically a management of access between applets belonging to separate contexts, according to the second embodiment.

In the context of the second embodiment, a particular use profile is defined. It is referred to as system profile PS. The system profile has particular access rights to the other use profiles, then referred to as ordinary profiles. By way of illustration, the profile PA already present in FIG. 3 is thus found in FIG. 4 (the profile PB could equally well have been shown in place of the profile PA).

In a particular embodiment, the system profile is a use profile associated with the applets instantiated by the manufacturer of the smartcard eUICC or of the electronic component iUICC. The system profile is responsible for downloading, installing and setting up the ordinary profiles. For example, considering the case where the smartcard eUICC is a SIM card, the system profile is associated with the manufacturer of the SIM card, and the ordinary profiles are associated with separate telephony operators with whom the user of the smartcard eUICC has taken out service subscriptions. The system profile thus enables in particular centralising all the data common to all the ordinary profiles, such as the administration data of the smartcard eUICC itself, e.g. ECASD (“eUICC Controlling Authority Secure Domain”) and ISD-R (“Issuer Security Domain-Root”). Each ordinary profile can also include administration data that are particular thereto, e.g. CASD (“Controlling Authority Secure Domain”). The same would apply in the context of use of the electronic component iUICC.

The profile PS contains a seventh context CS1 and an eighth context CS2. The seventh context CS1 contains an applet AS1. The eighth context CS2 contains an applet AS4. The profile PS further contains a ninth context JS intended for the applets instantiated by the JCRE environment when the profile PS is active. In FIG. 4, the ninth context JS contains an applet AS2 and an applet AS3. The profile PS can further contain static data SS common to the various contexts of the profile PS.

When an access is made between applets within the same use profile (intra-profile), the software firewall FW applies the intercontext access checking rules, namely in particular the usual access checking rules already evoked in Java Card technology (as are found in the Java Card Classic Platform version 3.0.4 specifications for example). The software firewall FW then checks with the targeted applet that the targeted applet provides a sharable interface and that said targeted applet thus enables access from another applet.

In addition, when an access is made from a first applet belonging to the profile PS to a second applet belonging to the profile PA, the software firewall FW accepts the access, and also applies the intercontext access checking rules. The software firewall FW thus checks in particular whether the second applet provides a sharable interface and thus allows access from another applet. The profile PS thus has access to the ordinary profiles PA and PB. In other words, this means that the software firewall FW applies the intercontext access checking rules, as if the access were intraprofile.

FIG. 4 thus illustrates that the software firewall FW accepts any access occurring from the profile PS to the profile PA (and the same would apply for any access occurring from the profile PS to the profile PB). In particular, FIG. 4 shows that the following accesses are accepted by the software firewall FW:
access from an applet of the context CS1 to an applet of the context CA1 (the same would apply to destined for the context CA2);
access from an applet of the context CS1 to an applet of the context JA (the same would apply from the context CS2);
access from an applet of the context JS to an applet of the context JA;
access from an applet of the context JS to an applet of the context CA2 (the same would apply to destined for the context CA1);
access from an applet of the context CS2 to an applet of the context CA2 (the same would apply to destined for the context CA1); and
access from an applet of the context CS2 to the static data SA (the same would apply from the context CS1).

Conversely, the accesses emanating from the profile PA (the same would apply coming from the profile PB) to the profile PS are refused by the software firewall FW, independently of any sharable interface of the applet to which access is intended.

Access to the static data of the profile PS is thus protected thanks to the software firewall FW. There is therefore no need for a context switch for this protection to be ensured. As listed above, this protection also extends to accesses involving context switches.

It will be noted, from a reading of the description of FIGS. 3 and 4, that each applet is associated with a single context and that each context is associated with one or more applets. It will also be noted that each context is associated with a single use profile and that each use profile is associated with one or more contexts.

FIG. 5A illustrates schematically an algorithm, implemented by the software firewall FW, for processing an interapplet access, according to the first embodiment.

In a step 501, the software firewall FW receives an access to be checked. The software firewall FW is informed thereof by the interpreter, namely the virtual machine JCVM. The access preferentially concerns a static data item. The same principle is however preferentially applied also to a non-static data item and/or to a method.

In a step 502, the software firewall FW determines a source profile of the access. In other words, the software firewall FW checks to which use profile the applet originating the access in question belongs. Information representing the active profile is supplied to the software firewall FW in parallel with the access to be checked.

In a step 503, the software firewall FW determines a profile for which the access is intended. In other words, the software firewall FW checks to which use profile the applet targeted by the access in question belongs. The access is intended for an object, relating to a given applet, instantiated in said estimation profile. This object preferentially contains information on said destination profile, in which said object is instantiated. Each object is thus auto-descriptive, as detailed previously.

It is also stated here that the other approach consists of including, in the software firewall FW, a table listing the use profiles existing on the smartcard eUICC or on the electronic component iUICC, as well as the contexts existing within each use profile, and the applets existing within each context. This table is updated at each use profile, context and applet instantiation. The software firewall FW thus finds in said table to which use profile the applet targeted by the access in question belongs.

In a step 504, the software firewall FW checks whether the access source profile determined at the step 502 is identical to the profile for which the access is intended, determined at the step 503. Typically, the active use profile, namely the source profile, is maintained in a persistent variable, to which the software firewall FW has access. When the access source profile is identical to the destination profile of the access, a step 506 is performed; otherwise a step 505 is performed.

In the step 505, the software firewall FW refuses access, independently of whether or not the applet targeted by the access provides a sharable interface. No access to the applet targeted by the access is therefore given. The algorithm in FIG. 5A is therefore ended.

In the step 506, the software firewall FW applies the aforementioned intercontext access checking rules. In other words, the software firewall FW checks in particular whether or not the applet targeted by the access provides a sharable interface. Thus, if the applet targeted by the access provides a sharable interface, access to the applet targeted by the access is given; otherwise access is refused and no access to the applet targeted by the access is given. The algorithm in FIG. 5A is then ended.

FIG. 5B illustrates schematically an algorithm, implemented by the software firewall, for processing an interapplet access, according to the second embodiment.

In a step 551, the software firewall FW receives an access to be checked. The step 551 is identical to the step 501. Thus the access relates preferentially to a static data item. The same principle is however preferentially applied also to a non-static data item and/or to a method.

In a step 552, the software firewall FW determines an access source profile. The step 552 is identical to the step 502.

In a step 553, the software firewall FW determines an access destination profile. The step 553 is identical to the step 503.

In a step 554, the software firewall FW checks whether the access source profile determined at the step 552 is identical to the access destination profile determined at the step 553. The step 554 is identical to the step 504. When the access source profile is identical to the access destination profile, a step 556 is performed; otherwise a step 560 is performed.

In the step 556, the software firewall FW applies the aforementioned intercontext access checking rules. In other words, the software firewall FW checks whether or not the applet targeted by the access provides a sharable interface. Thus, if the applet targeted by the access provides a sharable interface, access to the applet targeted by the access is given; otherwise access is refused and no access to the applet targeted by the access is given. The algorithm in FIG. 5B is then ended.

In the step 560, the software firewall FW checks whether the access source profile is the system profile PS. If such is the case, the step 556 is performed; otherwise a step 561 is performed. In other words, when the step 556 is here performed, the software firewall FW checks whether or not the applet targeted by the access provides a sharable interface. Thus, if the applet targeted by the access provides a sharable interface, access to the applet targeted by the access is given; otherwise access is refused and no access to the applet targeted by the access is given. The algorithm in FIG. 5B is then ended. Thus, unlike ordinary profiles, the system profile PS can perform accesses to the applets of other profiles if said applets respectively provide sharable interfaces.

In the step 561, the software firewall FW refuses access, independently of whether the applet targeted by the access provides a sharable interface. No access to the applet targeted by the access is therefore given. The algorithm in FIG. 5B is then ended.

1. A method for checking execution of applets developed in object-oriented language and compiled in bytecode, the method being implemented by a software firewall of an operating system installed in an electronic component of the integrated Universal Integrated Circuit Card iUICC type or on an electronic card of the embedded Universal Integrated Circuit Card eUICC type, the operating system comprising an interpreter that is a software interpreting and executing the bytecode of the applets, each applet being associated with a single context, each context being associated with one or more applets,
each context being associated with a single use profile among a plurality of use profiles, and each use profile being associated with one or more contexts,
wherein, when the software firewall is informed by the interpreter of an access to a static data item from a first applet to a second applet, the software firewall performs:
determining a source profile of the access to the static data item, which is the profile associated with the context with which the first applet is associated;
determining a destination profile of the access to the static data item, which is the profile associated with the context with which the second applet is associated;
checking whether the source profile of the access is identical to the destination profile of the access to the static data item;
when the source profile of the access to the static data item is not identical to the destination profile of the access to the static data item, refusing access to the static data item; and
when the source profile of the access to the static data item is identical to the destination profile of the access to the static data item, applying intercontext access checking rules.

2. The method according to claim 1, wherein one of said use profiles is a particular profile, referred to as a system profile, managed separately from the other use profiles by the software firewall, so that, when the source profile of the access to the static data item is the system profile, the software firewall applies the intercontext access checking rules and, when the destination profile of the access to the static data item is the system profile, the software firewall refuses access to the static data item.

3. The method according to claim 1, wherein, when the software firewall is informed by the interpreter of an access to a non-static data item or to a method from a first applet to a second applet, the software firewall performs:
determining the source profile of the access to the non-static data item or to the method;
determining the destination profile of the access to the non-static data item or to the method;
checking whether the source profile of the access to the non-static data item or to the method is identical to the destination profile of the access to the non-static data item or to the method;
when the source profile of the access to the non-static data item or to the method is not identical to the destination profile of the access to the non-static data item or to the method, refusing access to the non-static data item or to the method; and
when the source profile of the access to the non-static data item or to the method is identical to the destination profile of the access to the non-static data item or to the method, applying intercontext access checking rules.

4. The method according to claim 2, wherein, when the source profile of the access to the non-static data item or to the method is the system profile, the software firewall applies the intercontext access checking rules, and, when the destination profile of the access to the non-static data item or to the method is the system profile, the software firewall refuses access to the non-static data item or to the method.

5. The method according to claim 1, wherein, only one use profile being active at any one time, referred to as “active profile”, and the interpreter comprising an allocator responsible for memory allocations, the allocator provides the active profile in the header of any newly created object.

6. The method according to claim 1, wherein the electronic card of the eUICC type is a SIM card and the use profiles are respectively associated with separate operator telephony services.

7. A software firewall configured to perform a checking of execution of applets developed in object oriented language and compiled in byte code, the software firewall being intended to belong to an operating system intended to be installed in an electronic component of the integrated Universal Integrated Circuit Card iUICC type or on an electronic card of the embedded Universal Integrated Circuit Card eUICC type, the operating system comprising an interpreter that is a software interpreting and executing the bytecode of the applets, each applet being associated with a single context, each context being associated with one or more applets,
each context being associated with a single use profile among a plurality of use profiles, and each use profile being associated with one or more contexts,
wherein, when the software firewall is informed by the interpreter of an access to a static data item from a first applet to a second applet, the software firewall performs the following steps:
determining a source profile of the access to the static data item, which is the profile associated with the context with which the first applet is associated;
determining a destination profile of the access to the static data item, which is the profile associated with the context with which the second applet is associated;
checking whether the source profile of the access to the static data item is identical to the destination profile of the access to the static data item;
when the source profile of the access to the static data item is not identical to the destination profile of the access to the static data item, refusing access to the static data item; and
when the source profile of the access to the static data item is identical to the destination profile of the access to the static data item, applying intercontext access checking rules.

8. An electronic card of the embedded Universal Integrated Circuit Card eUICC type comprising an operating system integrating a software firewall according to claim 7, configured to perform a checking of execution of applets developed in object-oriented language and compiled in bytecode.

9. The electronic card of the eUICC type according to claim 8, wherein the electronic card of the eUICC type is a Subscriber Identity Module SIM card and the use profiles are respectively associated with telephony services of separate operators.

10. An electronic component of the integrated Universal Integrated Circuit Card iUICC type comprising an operating system integrating a software firewall according to claim 7, configured to perform a checking of execution of applets developed in object-oriented language and compiled in bytecode.

11. The method according to claim 3, wherein, when the source profile of the access to the non-static data item or to the method is the system profile, the software firewall applies the intercontext access checking rules, and, when the destination profile of the access to the non-static data item or to the method is the system profile, the software firewall refuses access to the non-static data item or to the method.
